(19) United States
(12) Patent Application Publication
(10) Pub. No.: US 2017/0091197 A1
(43) Pub. Date: Mar. 30, 2017

(54) Multimedia Display Method, Apparatus, and Device

(71) Applicant: Huawei Technologies Co., Ltd., Shenzhen (CN)

(72) Inventors: Yirong Qin, Shenzhen (CN); Minjiang Chen, Shenzhen (CN)

(21) Appl. No.: 15/311,764

(22) PCT Filed: May 19, 2014
(86) PCT No.: PCT/CN2014/077772

§ 371 Date: Nov. 16, 2016

(51) Int. Cl. G06F 17/30; H04L 29/08; G06F 3/0482; H04L 29/06

(52) U.S. Cl. CPC G06F 17/30058; H04L 65/1003; H04L 67/06; H04L 63/101; G06F 3/0482

(57) ABSTRACT

A multimedia display method includes receiving, by user equipment, a multimedia type selection command, searching for a service device in a specified range, and determining a service device accessible with access permission, where the service device stores a multimedia file, searching the service device accessible with access permission for a multimedia file corresponding to the multimedia type selection command, and generating and displaying a multimedia file list according to the multimedia file corresponding to the multimedia type selection command.

### CROSS-REFERENCE TO RELATED APPLICATIONS

This application is a National Stage of International Application No. PCT/CN2014/077772, filed on May 19, 2014, which is hereby incorporated by reference in its entirety.

### TECHNICAL FIELD

The present disclosure relates to the field of electronic information technologies, and in particular, to a multimedia display method, apparatus, and device.

### BACKGROUND

Currently, an in-car system based on an Android platform is already very popular. Generally, the in-car system can play only existent multimedia files in the in-car system. In order to widen the range of multimedia files that can be played by the in-car system and enable the in-car system to play multimedia files in other service devices, for example, use the in-car system to play a multimedia file in a mobile phone, and in order to enable the in-car system to play multimedia files in service devices such as a mobile phone, a Digital Living Network Alliance (DLNA) technology in which a DLNA service device collaborates with a DLNA in-car system to play multimedia files in service devices such as a mobile phone by using the in-car system is generally applied in the prior art. The DLNA in-car system displays multimedia type information. After receiving a multimedia type selection command of a user, the DLNA in-car system displays DLNA service devices that are searched out. After receiving a DLNA service device selection command of the user, the DLNA in-car system displays a catalog directory in a selected DLNA server, for example, a catalog directory based on path, based on artist, or based on album. After receiving a catalog directory selection command of the user, the DLNA in-car system displays a multimedia file list in the catalog directory. The DLNA in-car system receives a multimedia file selection command of the user, and selects and plays a multimedia file in the multimedia file list.

However, in the prior art, more than one DLNA service device generally exists in a range covered by a wireless network of the DLNA in-car system. Before accessing the DLNA service device, the DLNA in-car system does not know which multimedia files exist in the DLNA service device. If a DLNA service device includes no multimedia file desired by the user, the DLNA in-car system needs to return to an interface that displays the DLNA service device list and accesses another DLNA service device, receives a catalog directory selection command and then a multimedia file selection command of the user again, and selects and plays a multimedia file. In a case in which multiple DLNA service devices exist, the DLNA in-car system needs to access the DLNA service devices repeatedly. Every time a DLNA service device is accessed, multiple commands of the user need to be received before the desired multimedia file can be played. It takes a long time for the DLNA in-car system to search for the multimedia file, which reduces efficiency of searching for the multimedia file.

### SUMMARY

Embodiments of the present disclosure provide a multimedia display method, apparatus, and device, which can reduce time spent by user equipment in searching for a multimedia file and improve efficiency of searching for the multimedia file.

To achieve the foregoing objective, the embodiments of the present disclosure use the following technical solutions:

According to a first aspect, an embodiment of the present disclosure provides a multimedia display method, including receiving, by user equipment, a multimedia type selection command, searching for a service device in a specified range, and determining a service device accessible with access permission, where the service device stores a multimedia file, searching the service device accessible with access permission for a multimedia file corresponding to the multimedia type selection command, and generating and displaying a multimedia file list according to the multimedia file corresponding to the multimedia type selection command, where the multimedia list includes name information of the multimedia file corresponding to the multimedia type selection command.

With reference to the first aspect, in a first possible implementation manner, the searching the service device accessible with access permission for a multimedia file corresponding to the multimedia type selection command is acquiring a file directory from the service device accessible with access permission, where the file directory includes name information of at least one file in the service device, searching for the at least one file according to the name information of the at least one file in the file directory, acquiring file information of the at least one file according to the at least one file, where the file information of the at least one file is used to distinguish a type of the at least one file, and selecting, from the at least one file according to the file information of the at least one file, the multimedia file corresponding to the multimedia type selection command.

With reference to the first possible implementation manner of the first aspect, in a second possible implementation manner, the searching for the at least one file includes detecting whether a folder exists in the file directory, where the folder includes at least one file, and searching for the at least one file in the folder when the folder exists in the file directory, the acquiring file information of the at least one file according to the at least one file includes acquiring the file information of the at least one file in the folder according to the at least one file in the folder, and the selecting, from the at least one file according to the file information of the at least one file, the multimedia file corresponding to the multimedia type selection command includes selecting, from the at least one file in the folder according to the file information of the at least one file in the folder, the multimedia file corresponding to the multimedia type selection command.

With reference to the first aspect or the first or second possible implementation manner of the first aspect, in a third possible implementation manner, the method further includes receiving a selection play command, where the selection play command is used to select a to-be-played multimedia file from the multimedia list, acquiring a multimedia file corresponding to the selection play command from the service device according to the selection play command, and downloading a first download part of the multimedia file into a buffer of the user equipment, and playing the first download part.

With reference to the third possible implementation manner of the first aspect, in a fourth possible implementation manner, after the playing the first download part, the method further includes deleting the first download part of the multimedia file from the buffer of the user equipment.

According to a second aspect, an embodiment of the present disclosure provides a multimedia display apparatus, including a command receiving module configured to receive a multimedia type selection command, a service searching module configured to search for a service device in a specified range, and determine a service device accessible with access permission, where the service device stores a multimedia file, a file searching module configured to search the service device accessible with access permission for a multimedia file corresponding to the multimedia type selection command, and a list generating module configured to generate and display a multimedia file list according to the multimedia file corresponding to the multimedia type selection command, where the multimedia list includes name information of the multimedia file corresponding to the multimedia type selection command.

With reference to the second aspect, in a first possible implementation manner, the file searching module includes a directory acquiring unit configured to acquire a file directory from the service device accessible with access permission, where the file directory includes name information of at least one file in the service device, a searching unit configured to search for the at least one file according to the name information of the at least one file in the file directory, an information acquiring unit configured to acquire file information of the at least one file according to the at least one file, where the file information of the at least one file is used to distinguish a type of the at least one file, and a selecting unit configured to select, from the at least one file according to the file information of the at least one file, the multimedia file corresponding to the multimedia type selection command.

With reference to the first possible implementation manner of the second aspect, in a second possible implementation manner, the searching unit includes a detecting subunit configured to detect whether a folder exists in the file directory, where the folder includes at least one file, and a searching subunit configured to search for the at least one file in the folder when the folder exists in the file directory, the information acquiring unit includes an information acquiring subunit configured to acquire the file information of the at least one file in the folder according to the at least one file in the folder, and the selecting unit includes a selecting subunit configured to select, from the at least one file in the folder according to the file information of the at least one file in the folder, the multimedia file corresponding to the multimedia type selection command.

With reference to the second aspect or the first or second possible implementation manner of the second aspect, in a third possible implementation manner, the apparatus further includes a play command receiving module configured to receive a selection play command, where the selection play command is used to select a to-be-played multimedia file from the multimedia list, a file selecting module configured to acquire a multimedia file corresponding to the selection play command from the service device according to the selection play command, and a file playing module configured to download a first download part of the multimedia file into a buffer of the user equipment, and play the first download part.

With reference to the third possible implementation manner of the second aspect, in a fourth possible implementation manner, the apparatus further includes a deleting module configured to delete the first download part of the multimedia file from the buffer of the user equipment.

According to a third aspect, an embodiment of the present disclosure provides a multimedia display device, which includes at least a processor and a user interface, where the user interface is configured to receive a multimedia type selection command, and the processor is configured to search for a service device in a specified range, and determine a service device accessible with access permission, where the service device stores a multimedia file configured to search the service device accessible with access permission for a multimedia file corresponding to the multimedia type selection command, and configured to generate and display a multimedia file list according to the multimedia file corresponding to the multimedia type selection command, where the multimedia list includes name information of the multimedia file corresponding to the multimedia type selection command.

With reference to the third aspect, in a first possible implementation manner, the processor is further configured to acquire a file directory from the service device accessible with access permission, where the file directory includes name information of at least one file in the service device configured to search for the at least one file according to the name information of the at least one file in the file directory configured to acquire file information of the at least one file according to the at least one file, where the file information of the at least one file is used to distinguish a type of the at least one file, and configured to select, from the at least one file according to the file information of the at least one file, the multimedia file corresponding to the multimedia type selection command.

With reference to the first possible implementation manner of the third aspect, in a second possible implementation manner, the processor is further configured to detect whether a folder exists in the file directory, where the folder includes at least one file, and search for the at least one file in the folder when the folder exists in the file directory configured to acquire the file information of the at least one file in the folder according to the at least one file in the folder, and configured to select, from the at least one file in the folder according to the file information of the at least one file in the folder, the multimedia file corresponding to the multimedia type selection command.

With reference to the third aspect or the first or second possible implementation manner of the third aspect, in a third possible implementation manner, the user interface is further configured to receive a selection play command, where the selection play command is used to select a to-be-played multimedia file from the multimedia list, and the processor is further configured to acquire a multimedia file corresponding to the selection play command from the service device according to the selection play command, and download a first download part of the multimedia file into a buffer of the user equipment, and play the first download part.

With reference to the third possible implementation manner of the third aspect, in a fourth possible implementation manner, the processor is further configured to delete the first download part of the multimedia file from the buffer of the user equipment.

In the multimedia display method, apparatus, and device provided in the embodiments of the present disclosure, user equipment can receive a multimedia type selection command, search for a service device in a specified range, determine a service device accessible with access permission, search the service device accessible with access permission for a multimedia file corresponding to the multimedia type selection command, and generate and display a multimedia file list according to the multimedia file corresponding to the multimedia type selection command. In the prior art, a DLNA service device needs to be accessed repeatedly, and every time the DLNA service device is accessed, multiple commands of a user need to be received before a required multimedia file can be played. Compared with the prior art, in this solution, after receiving a multimedia type selection command, the user equipment traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the user equipment in searching for a multimedia file and, improving efficiency of searching for the multimedia file.

### BRIEF DESCRIPTION OF DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a multimedia display method according to an embodiment of the present disclosure.

FIG. 2A is a schematic diagram of an interface displayed by user equipment in the prior art.

FIG. 2B is a schematic diagram of an interface displayed by user equipment according to an embodiment of the present disclosure.

FIG. 3A is a flowchart of a multimedia display method according to another embodiment of the present disclosure.

FIG. 3B is a schematic diagram of an example of a file directory according to another embodiment of the present disclosure.

FIG. 4A is a flowchart of a multimedia display method according to another embodiment of the present disclosure.

FIG. 4B is a schematic diagram of an example of a file directory according to another embodiment of the present disclosure.

FIG. 5 is a flowchart of a multimedia display method according to another embodiment of the present disclosure.

FIG. 6 is a schematic structural diagram of a multimedia display apparatus according to an embodiment of the present disclosure.

FIG. 7 is a schematic structural diagram of a multimedia display apparatus according to another embodiment of the present disclosure.

FIG. 8 is a schematic structural diagram of a multimedia display apparatus according to another embodiment of the present disclosure.

FIG. 9 is a schematic structural diagram of a multimedia display apparatus according to another embodiment of the present disclosure.

FIG. 10 is a schematic structural diagram of a multimedia display device according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

The technical solution provided in the embodiments of the present disclosure is applied to user equipment. The user equipment may communicate with a service device accessible with access permission, and the service device stores a multimedia file. There may be multiple service devices, and the user equipment may acquire a multimedia file from the service device and plays it on the user equipment. The user equipment may be an in-car system on which a DLNA client is installed or another device that can communicate with the service device. The service device may be a mobile phone, a tablet computer, a notebook computer, and the like. The user equipment and the service device may communicate by using a wireless communication technology such as wireless local area network(Wi-Fi), BLUETOOTH, or the like.

An embodiment of the present disclosure provides a multimedia display method, as shown in FIG. 1, the method includes the following steps:

101. User equipment receives a multimedia type selection command.

The multimedia type selection command is used to select a multimedia type, and the multimedia type selection command may be set and sent by a user. For example, the user equipment displays three types of multimedia file icons music, movie, and image. The user sends a multimedia type selection command to select a music icon, and therefore, the user equipment receives the multimedia type selection command that is used to select a music multimedia file.

102. Search for a service device in a specified range, and determine a service device accessible with access permission.

The service device stores a multimedia file. Receiving a multimedia type selection command is a condition of triggering search for a service device. After receiving the multimedia type selection command, the user equipment starts to search for a service device in a specified range. The user equipment searches for the service device in the specified range, where the specified range may be a range in which the user equipment can communicate with the service device, for example, a range covered by a wireless local area network connected to the user equipment, and the specified range may also be a distance range set by the user, for example, a range in a circle with a center at the user equipment and a radius equal to 5 meters.

It should be noted that the user equipment may search out multiple service devices, and needs to determine a service device accessible with access permission. For example, the user equipment is an in-car system, and the in-car system searches out a mobile phone A, a mobile phone B, and a tablet computer C. The mobile phone A, the mobile phone B, and the tablet computer C are all service devices, however, only the mobile phone A and the tablet computer C have matching clients installed on them and are accessible with access permission, and therefore, the in-car system can access only the mobile phone A and the tablet computer C.

103. Search the service device accessible with access permission for a multimedia file corresponding to the multimedia type selection command.

The user equipment searches the service device accessible with access permission for a multimedia file corresponding to the multimedia type selection command. For example, multimedia files stored in the service devices include a music file, a video file, an image file, and the like. A music file is selected according to the multimedia type selection command, and therefore, all music files in the found service device accessible with access permission are acquired from the found service device accessible with access permission. When searching the service device accessible with access permission for the multimedia file corresponding to the multimedia type selection command, the user equipment may successively perform the search in multiple service devices accessible with access permission, or may concurrently perform the search in the multiple service devices accessible with access permission to further improve search efficiency. The user equipment and the service device may also communicate and exchange data and messages by using a Universal Plug and Play (UPNP) protocol.

104. Generate and display a multimedia file list according to the multimedia file corresponding to the multimedia type selection command.

The multimedia list includes name information of the multimedia file corresponding to the multimedia type selection command. For example, when the multimedia list is generated and displayed, the user equipment does not download the multimedia file that is corresponding to the multimedia type selection command and is in the service device into the user equipment. For example, the multimedia type selection command instructs to select a video file, and therefore, the multimedia list displayed by the user equipment includes name information of video files in all service devices accessible with access permission. The multimedia list includes at least the name information of the multimedia file, and may further include other information such as an album or author of the multimedia file. There are multiple types for the multimedia file, such as a music file, an image file, and a video file.

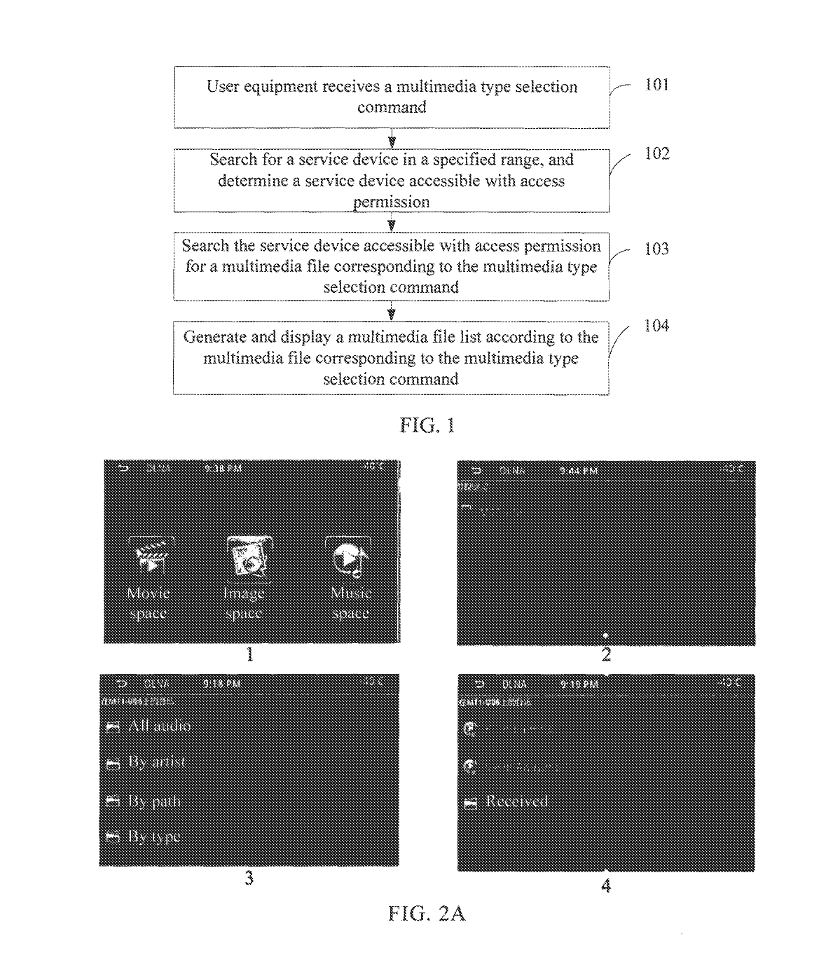

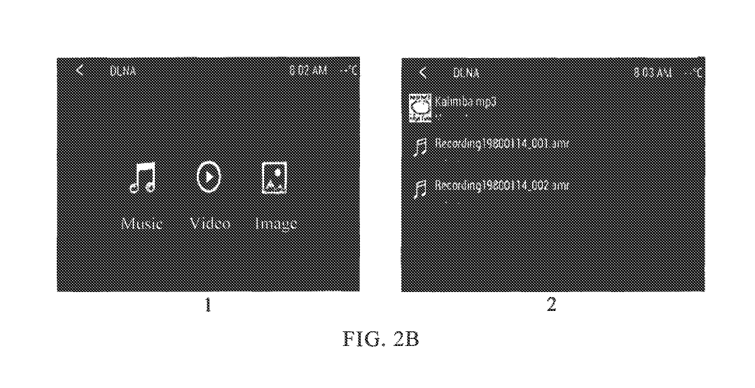

As shown in FIG. 2A, an operation command of a user is received, and user equipment needs to display successively four interfaces numbered 1-4. The interface numbered 1 is a multimedia type selection interface, the interface numbered 2 is a service device selection interface, the interface numbered 3 is a directory type selection interface, and the interface numbered 4 is a multimedia file list interface. When one service device is accessed, the user equipment needs to receive an operation command four times before a multimedia file desired for playing can be selected on the multimedia file list interface. If a user terminal accesses N service devices successively, the user equipment needs to receive the operation command 4*N times and perform an operation 4*N times. However, in this solution, as shown in FIG. 2B, the user equipment needs only to display successively two interfaces numbered 1 and 2. The interface numbered 1 is a multimedia type selection interface, and the interface numbered 2 is a multimedia file list interface. The user equipment needs to receive the operation command only two times before the multimedia file desired for playing can be selected on the multimedia file list interface. Even if the user equipment accesses multiple service devices, because selection of the service device is not required, the user equipment still needs to receive the operation command only two times before the multimedia file desired for playing can be selected on the multimedia file list interface.

In the multimedia display method provided in this embodiment of the present disclosure, user equipment can receive a multimedia type selection command, search for a service device in a specified range, determine a service device accessible with access permission, search the service device accessible with access permission for a multimedia file corresponding to the multimedia type selection command, and generate and display a multimedia file list according to the multimedia file corresponding to the multimedia type selection command. In the prior art, a DLNA service device needs to be accessed repeatedly, and every time the DLNA service device is accessed, multiple commands of a user need to be received before a required multimedia file can be played. Compared with the prior art, in this solution, after receiving a multimedia type selection command, the user equipment traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the user equipment in searching for a multimedia file, and improving efficiency of searching for the multimedia file.

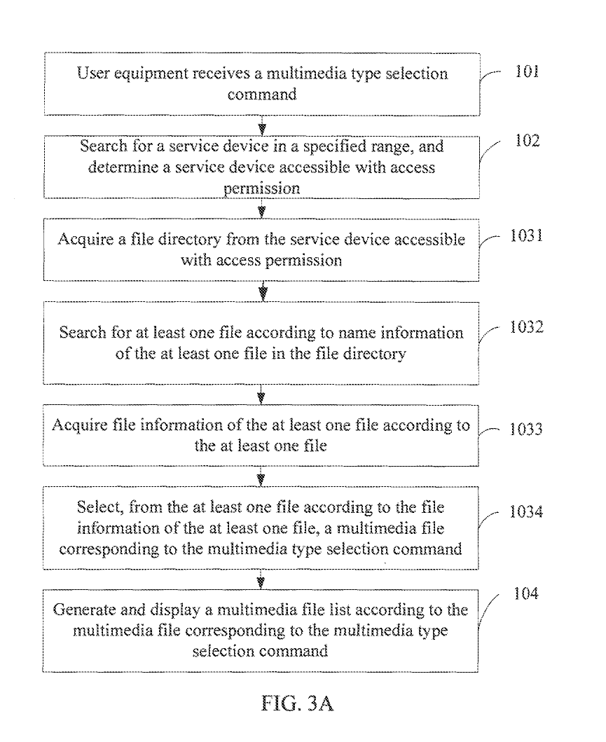

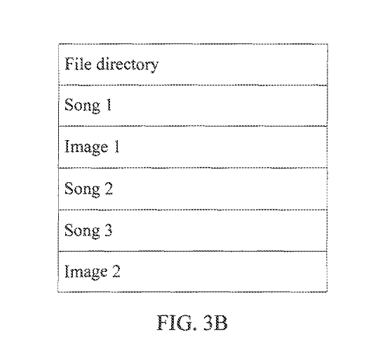

Further, on the basis of the solution shown in FIG. 1, another embodiment of the present disclosure further provides a specific solution to a multimedia display method. This solution gives more details about an execution process of 103 in the solution shown in FIG. 1, where 103 may be implemented by 1031 to 1033, and as shown in FIG. 3A, may include the following steps:

1031. Acquire a file directory from the service device accessible with access permission.

In specific application of this embodiment, the service device may use a file directory to display files stored in the service device, where the file directory includes name information of at least one file in the service device, and the file may include a multimedia file and may further include a file of another type, such as an executable program file and a text file. For example, as shown in FIG. 3B, the file directory includes name information of five files which are separately “song 1”, “image 1”, “song 2”, “song 3”, and “image 2”. The user equipment acquires a file directory from the service device accessible with access permission. The file directory is essentially an index that is of files in the service device and is created by the service device. That is, the index is a mapping relationship between name information of a file and a physical location of the file. Each file in the service device has a corresponding entry in the file directory. The entry includes at least the name information of the file, and may further include information such as an internal identifier of the file, a file type, a file storage address, a file length, access permission, creation time, and access time. A corresponding file may be found in a physical memory according to the name information of the file in the file directory.

1032. Search for at least one file according to name information of the at least one file in the file directory.

A physical memory of the service device may be searched for a corresponding file according to the name information of the file in the file directory in the service device.

1033. Acquire file information of the at least one file according to the at least one file.

The file information of the at least one file is used to distinguish a type of the at least one file. According to the found file, the file information of the file may be acquired by using a property of the file. The file information is used to distinguish the file type. The file information may be file format information such as Text File (txt), Audio Video Interleaved (avi), Moving Picture Experts Group Audio Layer III (MP3), and Graphics Interchange Format (GIF). The file information may also be identification information that identifies a multimedia file type. For example, the user equipment and the service device pre-agrees to set identification information that identifies a multimedia file type, uses a character A to identify a music file, uses a character B to identify an image file, and uses a character C to identify a video file.

1034. Select, from the at least one file according to the file information of the at least one file, a multimedia file corresponding to the multimedia type selection command.

According to the file information of at least one file, the user equipment may determine a type of the file, and therefore, selects the multimedia file that is corresponding to the multimedia type selection command and is in plenty of files in the service device. For example, the files stored in the service device include a text file, an image file, a video file, a music file, and the like. When the file information is file format information, the multimedia type selection command instructs to select a video file, and therefore, file format information of all files in the service device is acquired. The service device stores files whose file format information is txt, avi files, MP3 files, Flash Video, a streaming media format (FLV) files, and GIF files. The files whose file format information is avi and FLV are video files, and therefore, the user equipment selects files whose file format information is avi and FLV in all files.

In the multimedia display method provided in this embodiment of the present disclosure, user equipment can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. In the prior art, a DLNA service device needs to be accessed repeatedly, and every time the DLNA service device is accessed, multiple commands of a user need to be received before a required multimedia file can be played. Compared with the prior art, in this solution, after receiving a multimedia type selection command, the user equipment traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the user equipment in searching for a multimedia file, and improving efficiency of searching for the multimedia file.

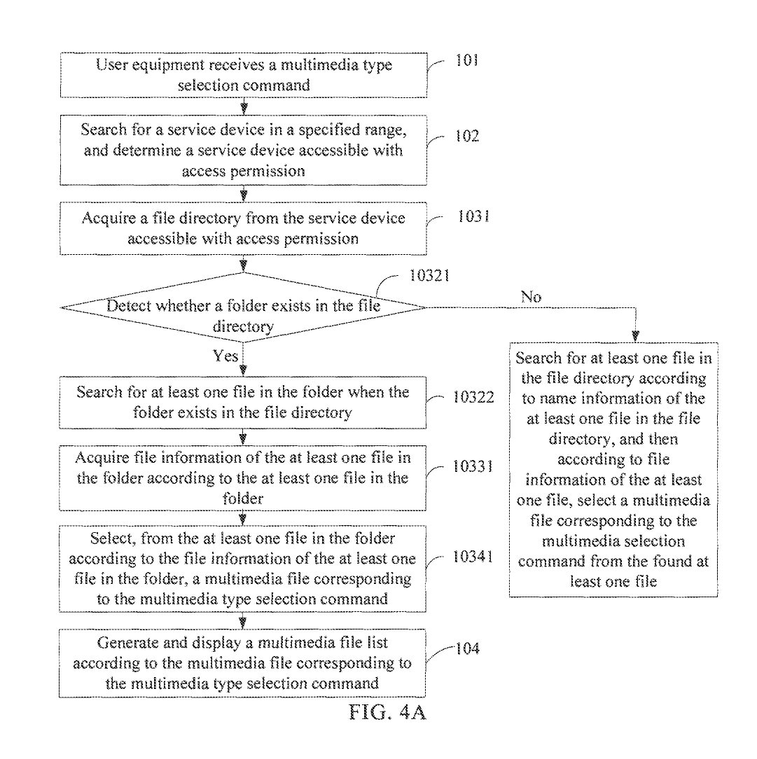

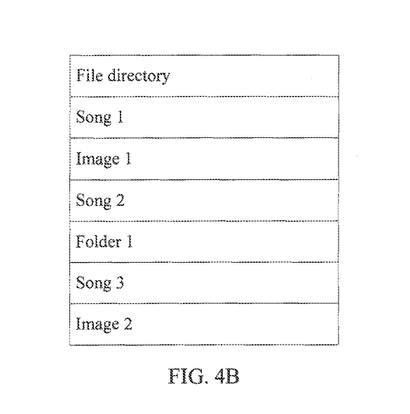

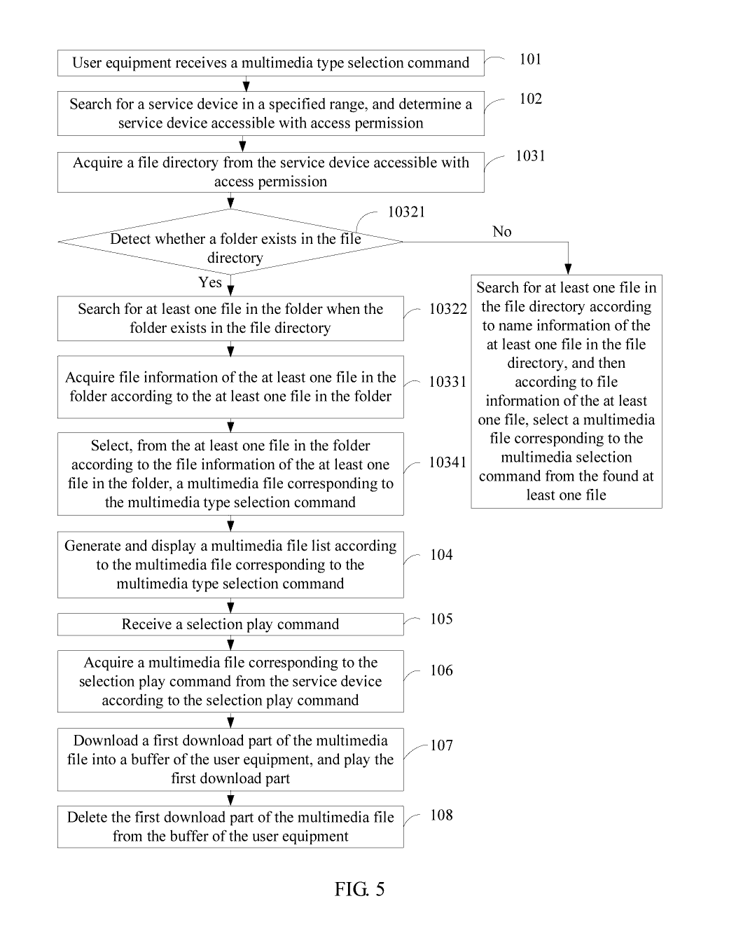

Still further, on the basis of the solution shown in FIG. 3A, an embodiment of the present disclosure further provides a specific solution to a multimedia display method. This solution gives more details about an execution process of 1032 to 1034 in the solution shown in FIG. 3A, where 1032 may be implemented by 10321 to 10322, 1033 may be implemented by 10331, and 1034 may be implemented by 10341. As shown in FIG. 4A, the implementation process includes the following steps:

10321. Detect whether a folder exists in the file directory.

A folder may still exist in the file directory, and the folder includes at least one file. In order to prevent omission of a multimedia file that is corresponding to the multimedia type selection command and is in the folder at the time of selecting the multimedia file corresponding to the multimedia type selection command, whether a folder exists in the file directory needs to be detected, and if a folder exists, the folder needs to be opened and at least one file in the folder needs to be selected.

10322. Search for at least one file in the folder when the folder exists in the file directory.

When a folder exists in the file directory, the folder is opened and at least one file in the folder is searched for. For example, as shown in FIG. 4B, the file directory includes not only name information of five files “song1”, “image1”, “song 2”, “song 3”, and “image 2”, but also a folder “folder 1”, and therefore, the folder 1 is opened and a file in the folder 1 is searched for.

When no folder exists in the file directory, it is necessary only to search for at least one file in the file directory according to the name information of the at least one file in the file directory, and then according to the file information of the at least one file, select a multimedia file that is corresponding to the multimedia selection command and is in the found at least one file.

It should be noted that the folder may further include a subfolder. In this case, the subfolder is opened and at least one file in the subfolder is searched for until the folder includes no subfolder.

10331. Acquire the file information of the at least one file in the folder according to the at least one file in the folder.

The file information is one of properties of the file. In the service device, the user equipment can acquire the file information of the at least one file in the folder according to the at least one file in the folder.

10341. Select, from the at least one file in the folder according to the file information of the at least one file in the folder, a multimedia file corresponding to the multimedia type selection command.

The multimedia file corresponding to the multimedia type selection command is selected from the at least one file in the folder by using the file information of the at least one file in the folder. If the folder still includes a subfolder, the subfolder is opened, and a multimedia file corresponding to the multimedia type selection command is selected from at least one file in the subfolder according to file information of the at least one file in the subfolder, which goes on until the folder includes no subfolder.

In the multimedia display method provided in this embodiment of the present disclosure, user equipment can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. A DLNA service device typically needs to be accessed repeatedly, and every time the DLNA service device is accessed, multiple commands of a user need to be received before a required multimedia file can be played. Compared with the prior art, in this solution, after receiving a multimedia type selection command, the user equipment traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the user equipment in searching for a multimedia file, and improving efficiency of searching for the multimedia file. When the file directory includes a folder, the folder is opened and a multimedia file corresponding to the multimedia type selection command is selected, thereby preventing omission of the multimedia file corresponding to the multimedia type selection command.

In addition, on the basis of the solution shown in FIG. 4A, an embodiment of the present disclosure further provides a specific solution to a multimedia display method. In this solution, 105 to 108 may be added, and a multimedia file in a service device may be downloaded to user equipment and played. As shown in FIG. 5, the specific solution includes the following steps:

105. Receive a selection play command.

The selection play command is used to select a to-be-played multimedia file from the multimedia list.

106. Acquire a multimedia file corresponding to the selection play command from the service device according to the selection play command.

107. Download a first download part of the multimedia file into a buffer of the user equipment, and play the first download part.

The first download part may be set as a part in a preset time in the multimedia file to enable the user equipment to implement a function of playing while downloading. For example, the multimedia file is a video file. When the video file is played to 1 minute, the user equipment needs only to download a part between 1 minute and 1 minute 30 seconds in the video file from the service device, and so on. A part to be downloaded in real time is always the part of 30 seconds after current time of playing the video. In this way, it can be avoided that an entire multimedia file is downloaded by the user into the user equipment, which occupies plenty of storage resources of a memory in the user equipment. The first download part may also be set as a part of a preset size in the multimedia file. For example, the first download part may be a part of a 10 M size that is to be played immediately in the multimedia file.

108. Delete the first download part of the multimedia file from the buffer of the user equipment.

After the first download part of the multimedia file is played, the first download part is deleted from a buffer of the user equipment in real time, thereby preventing an increase in a burden on the memory of the user equipment and reducing occupied storage resources.

In the multimedia display method provided in this embodiment of the present disclosure, user equipment can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. When a multimedia file is played, it may be downloaded while being played, and a played part of the multimedia file may be deleted. In the prior art, a DLNA service device needs to be accessed repeatedly, and every time the DLNA service device is accessed, multiple commands of a user need to be received before a required multimedia file can be played. Compared with the prior art, in this solution, after receiving a multimedia type selection command, the user equipment traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the user equipment in searching for a multimedia file, and improving efficiency of searching for the multimedia file. In addition, in a process of playing, storage resources occupied in the user equipment are reduced maximally, and a storage burden on a memory of the user equipment is also relieved.

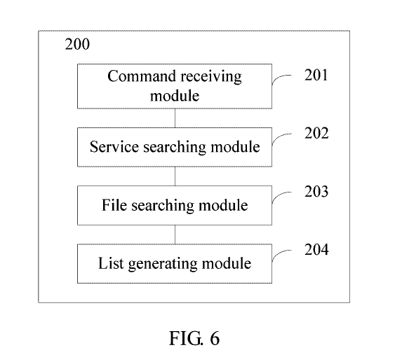

An embodiment of the present disclosure provides user equipment 200. As shown in FIG. 6, the user equipment 200 includes a command receiving module 201 configured to receive a multimedia type selection command, a service searching module 202 configured to search for a service device in a specified range, and determine a service device accessible with access permission, where the service device stores a multimedia file, a file searching module 203 configured to search the service device accessible with access permission for a multimedia file corresponding to the multimedia type selection command, and a list generating module 204 configured to generate and display a multimedia file list according to the multimedia file corresponding to the multimedia type selection command.

The multimedia list includes name information of the multimedia file corresponding to the multimedia type selection command.

The multimedia display apparatus provided in this embodiment of the present disclosure can receive a multimedia type selection command, search for a service device in a specified range, determine a service device accessible with access permission, search the service device accessible with access permission for a multimedia file corresponding to the multimedia type selection command, and generate and display a multimedia file list according to the multimedia file corresponding to the multimedia type selection command. In the prior art, a DLNA service device needs to be accessed repeatedly, and every time the DLNA service device is accessed, multiple commands of a user need to be received before a required multimedia file can be played. Compared with the prior art, in this solution, after receiving a multimedia type selection command, the apparatus traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the apparatus in searching for a multimedia file, and improving efficiency of searching for the multimedia file.

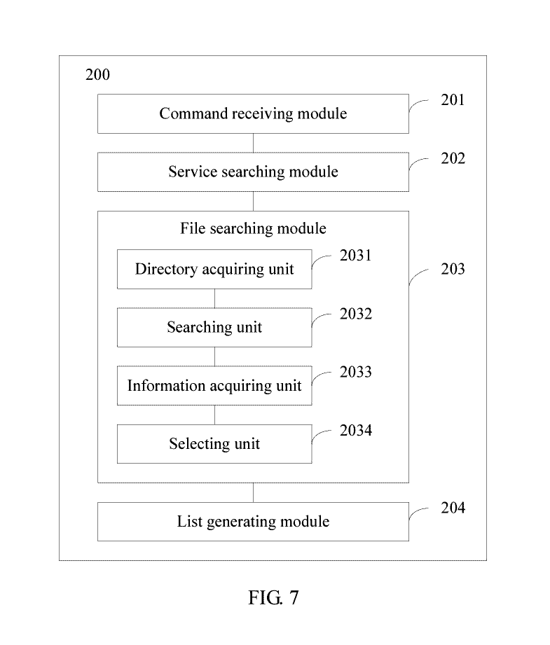

Further, as shown in FIG. 7, the file searching module 203 includes a directory acquiring unit 2031 configured to acquire a file directory from the service device accessible with access permission, where the file directory includes name information of at least one file in the service device, a searching unit 2032 configured to search for the at least one file according to the name information of the at least one file in the file directory, an information acquiring unit 2033 configured to acquire file information of the at least one file according to the at least one file, where the file information of the at least one file is used to distinguish a type of the at least one file, and a selecting unit 2034 configured to select, from the at least one file according to the file information of the at least one file, the multimedia file corresponding to the multimedia type selection command.

The multimedia display apparatus provided in this embodiment of the present disclosure can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. A DLNA service device typically needs to be accessed repeatedly, and every time the DLNA service device is accessed, multiple commands of a user need to be received before a required multimedia file can be played. Compared with the prior art, in this solution, after receiving a multimedia type selection command, the apparatus traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the apparatus in searching for a multimedia file, and improving efficiency of searching for the multimedia file.

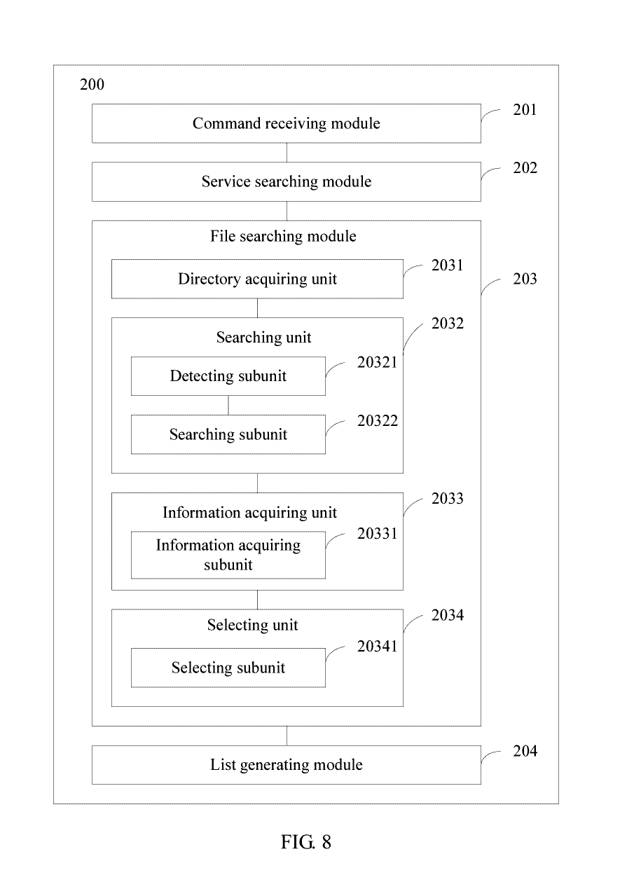

Still further, as shown in FIG. 8, the searching unit 2032 includes a detecting subunit 20321 configured to detect whether a folder exists in the file directory, where the folder includes at least one file, and a searching subunit 20322 configured to search for the at least one file in the folder when the folder exists in the file directory.

The information acquiring unit 2033 includes an information acquiring subunit 20331 configured to acquire the file information of the at least one file in the folder according to the at least one file in the folder.

The selecting unit 2034 includes a selecting subunit 20341 configured to select, from the at least one file in the folder according to the file information of the at least one file in the folder, the multimedia file corresponding to the multimedia type selection command.

The multimedia display apparatus provided in this embodiment of the present disclosure can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. A DLNA service device typically needs to be accessed repeatedly, and every time the DLNA service device is accessed, multiple commands of a user need to be received before a required multimedia file can be played. Compared with the prior art, in this solution, after receiving a multimedia type selection command, the user equipment traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the user equipment in searching for a multimedia file, and improving efficiency of searching for the multimedia file. When the file directory includes a folder, the folder is opened and a multimedia file corresponding to the multimedia type selection command is selected, thereby preventing omission of the multimedia file corresponding to the multimedia type selection command.

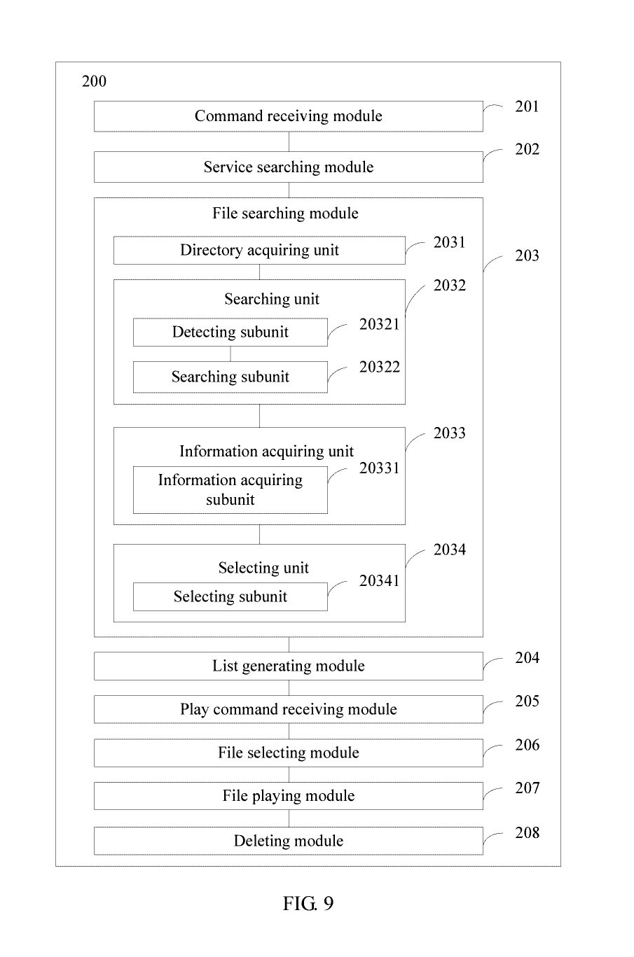

In addition, as shown in FIG. 9, the user equipment 200 further includes a play command receiving module 205 configured to receive a selection play command, where the selection play command is used to select a to-be-played multimedia file from the multimedia list, a file selecting module 206 configured to acquire a multimedia file corresponding to the selection play command from the service device according to the selection play command, a file playing module 207 configured to download a first download part of the multimedia file into a buffer of the user equipment, and play the first download part, and a deleting module 208 configured to delete the first download part of the multimedia file from the buffer of the user equipment.

The multimedia display apparatus provided in this embodiment of the present disclosure can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. When a multimedia file is played, it may be downloaded while being played, and a played part of the multimedia file may be deleted. A DLNA service device typically needs to be accessed repeatedly, and every time the DLNA service device is accessed, multiple commands of a user need to be received before a required multimedia file can be played. Compared with the prior art, in this solution, after receiving a multimedia type selection command, the apparatus traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the apparatus in searching for a multimedia file, and improving efficiency of searching for the multimedia file. In addition, in a process of playing, storage resources occupied in the apparatus are reduced maximally, and a storage burden on a memory of the apparatus is also relieved.

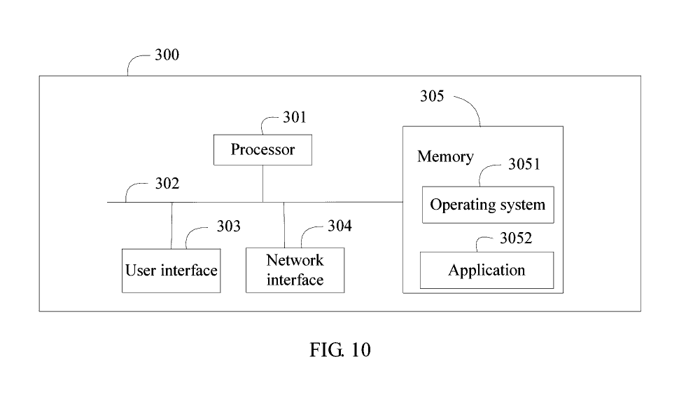

An embodiment of the present disclosure provides a multimedia display device 300. As shown in FIG. 10, the multimedia display device 300 includes at least one processor 301 such as a Central Processing Unit (CPU), at least one network interface 304 or another user interface 303, a memory 305, and at least one communications bus 302. The communications bus 302 is used to implement connection and communication between these components. In an embodiment, the user interface 303 may be a display, a keyboard or a click device such as a mouse, a trackball, a touchpad or a touchscreen. In an embodiment, the memory 305 may include at least one storage apparatus located far away from the processor 301, such as a read-only memory (ROM) or a random access memory (RAM), and the multimedia display device 300 may be a vehicle-mounted play device or a home play device such as a vehicle-mounted player or a smart television.

In some implementation manners, the memory 305 stores the following elements, an executable module or a data structure, or a subset thereof, or an extension set thereof an operating system 3051, including various system programs, and configured to implement various basic services and handle hardware-based tasks, and an application 3052, including various applications, and configured to implement various application services.

The application 3052 includes but is not limited to a command receiving module 201, a service searching module 202, a file searching module 203, a list generating module 204, a directory acquiring unit 2031, a searching unit 2032, an information acquiring unit 2033, a selecting unit 2034, a detecting subunit 20321, a searching subunit 20322, an information acquiring subunit 20331, a selecting subunit 20341, a play command receiving module 205, a file selecting module 206, a file playing module 207, and a deleting module 208.

For specific implementation of each module and each unit in the application 3052, reference may be made to corresponding modules and units in the embodiments shown in FIG. 6 to FIG. 9, and details are not described herein again. The processor 301 may acquire data such as the operating system 3051 and the application 3052 from the memory 305 such that the processor 301 runs or executes the data such as the operating system 3051 and the application 3052.

In an embodiment, the user interface 303 is configured to receive a multimedia type selection command.

The processor 301 is configured to search for a service device in a specified range, and determine a service device accessible with access permission, where the service device stores a multimedia file configured to search the service device accessible with access permission for a multimedia file corresponding to the multimedia type selection command, and configured to generate and display a multimedia file list according to the multimedia file corresponding to the multimedia type selection command, where the multimedia list includes name information of the multimedia file corresponding to the multimedia type selection command.

The memory 305 is configured to store the multimedia type selection command and the multimedia file list.

Further, the processor 301 is further configured to acquire a file directory from the service device accessible with access permission, where the file directory includes name information of at least one file in the service device configured to search for the at least one file according to the name information of the at least one file in the file directory configured to acquire file information of the at least one file according to the at least one file, where the file information of the at least one file is used to distinguish a type of the at least one file, and configured to select, from the at least one file according to the file information of the at least one file, the multimedia file corresponding to the multimedia type selection command.

Still further, the processor 301 is further configured to detect whether a folder exists in the file directory, where the folder includes at least one file, and search for the at least one file in the folder when the folder exists in the file directory configured to acquire the file information of the at least one file in the folder according to the at least one file in the folder, and configured to select, from the at least one file in the folder according to the file information of the at least one file in the folder, the multimedia file corresponding to the multimedia type selection command.

In addition, the user interface 303 is further configured to receive a selection play command.

The selection play command is used to select a to-be-played multimedia file from the multimedia list.

The processor 301 is further configured to acquire a multimedia file corresponding to the selection play command from the service device according to the selection play command, and download a first download part of the multimedia file into a buffer of the user equipment, and play the first download part.

The processor 301 is further configured to delete the first download part of the multimedia file from the buffer of the user equipment.

The multimedia display device provided in this embodiment of the present disclosure can receive a multimedia type selection command, search for a service device in a specified range, determine a service device accessible with access permission, acquire a file directory from the service device accessible with access permission, and therefore, acquire file information of a file in the service device, select a multimedia file corresponding to the multimedia type selection command by using the file information, and generate and display a multimedia file list according to the multimedia file corresponding to the multimedia type selection command. When a multimedia file is played, it may be downloaded while being played, and a played part of the multimedia file may be deleted. In the prior art, a DLNA service device needs to be accessed repeatedly, and every time the DLNA service device is accessed, multiple commands of a user need to be received before a required multimedia file can be played. Compared with the prior art, in this solution, after receiving a multimedia type selection command, the multimedia display device traverses and accesses all found service devices accessible with access permission, generates and displays a multimedia file list according to a multimedia file that is corresponding to the multimedia type selection command and is in the service device, and displays found multimedia files at a time, thereby avoiding a problem of accessing the DLNA service device repeatedly, avoiding a need of receiving multiple commands of the user every time the DLNA service device is accessed, reducing time spent by the multimedia display device in searching for a multimedia file, and improving efficiency of searching for the multimedia file. When the file directory includes a folder, the folder is opened to acquire a multimedia file, thereby preventing omission of a multimedia file corresponding to the multimedia type selection command. In addition, in a process of playing, storage resources occupied in the multimedia display device are reduced maximally, and a storage burden on a memory of the multimedia display device is also relieved.

The embodiments in this specification are all described in a progressive manner, for same or similar parts in the embodiments, reference may be made to these embodiments, and each embodiment focuses on a difference from other embodiments. Especially, a device embodiment is basically similar to a method embodiment, and therefore is described briefly, for related parts, reference may be made to partial descriptions in the method embodiment.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The storage medium may include a magnetic disk, an optical disc, a ROM, or a RAM.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A multimedia display method, comprising:
receiving, by user equipment, a multimedia type selection command;
searching for a service device in a specified range;
determining a service device accessible with an access permission, wherein the service device stores a multimedia file;
searching the service device accessible with the access permission for the multimedia file corresponding to the multimedia type selection command; and
generating and displaying a multimedia file list according to the multimedia file corresponding to the multimedia type selection command, wherein the multimedia list comprises name information of the multimedia file corresponding to the multimedia type selection command.

2. The method according to claim 1, wherein searching the service device accessible with the access permission for the multimedia file corresponding to the multimedia type selection command comprises:
acquiring a file directory from the service device accessible with the access permission, wherein the file directory comprises name information of at least one file in the service device;
searching for the at least one file according to the name information of the at least one file in the file directory;
acquiring file information of the at least one file according to the at least one file, wherein the file information of the at least one file is used to distinguish a type of the at least one file; and
selecting, from the at least one file according to the file information of the at least one file, the multimedia file corresponding to the multimedia type selection command.

3. The method according to claim 2, wherein searching for the at least one file comprises:
detecting whether a folder exists in the file directory, wherein the folder comprises the at least one file; and
searching for the at least one file in the folder when the folder exists in the file directory, wherein acquiring the file information of the at least one file according to the at least one file comprises acquiring the file information of the at least one file in the folder according to the at least one file in the folder, and wherein selecting, from the at least one file according to the file information of the at least one file, the multimedia file corresponding to the multimedia type selection command comprises selecting, from the at least one file in the folder according to the file information of the at least one file in the folder, the multimedia file corresponding to the multimedia type selection command.

4. The method according to claim 1, further comprising:
receiving a selection play command used to select a to-be-played multimedia file from the multimedia file list;
acquiring a multimedia file corresponding to the selection play command from the service device according to the selection play command;
downloading a first download part of the multimedia file into a buffer of the user equipment; and
playing the first download part.

5. The method according to claim 4, wherein after playing the first download part, the method further comprises deleting the first download part of the multimedia file from the buffer of the user equipment.

6. A multimedia display apparatus, comprising:
a receiver configured to receive a multimedia type selection command; and
a processor coupled to the receiver and configured to:
search for a service device in a specified range;
determine the service device accessible with an access permission, wherein the service device stores a multimedia file;
search the service device accessible with the access permission for the multimedia file corresponding to the multimedia type selection command; and
generate and display a multimedia file list according to the multimedia file corresponding to the multimedia type selection command, wherein the multimedia list comprises name information of the multimedia file corresponding to the multimedia type selection command.

7. The apparatus according to claim 6, wherein the processor is further configured to:
acquire a file directory from the service device accessible with the access permission, wherein the file directory comprises name information of at least one file in the service device;
search for the at least one file according to the name information of the at least one file in the file directory;
acquire file information of the at least one file according to the at least one file, wherein the file information of the at least one file is used to distinguish a type of the at least one file; and
select, from the at least one file according to the file information of the at least one file, the multimedia file corresponding to the multimedia type selection command.

8. The apparatus according to claim 7, wherein the processor is further configured to:
detect whether a folder exists in the file directory, wherein the folder comprises the at least one file;
search for the at least one file in the folder when the folder exists in the file directory;
acquire the file information of the at least one file in the folder according to the at least one file in the folder; and
select, from the at least one file in the folder according to the file information of the at least one file in the folder, the multimedia file corresponding to the multimedia type selection command.

9. The apparatus according to claim 6, wherein the processor is further configured to:
receive a selection play command used to select a to-be-played multimedia file from the multimedia file list;
acquire a multimedia file corresponding to the selection play command from the service device according to the selection play command;
download a first download part of the multimedia file into a buffer of the user equipment; and
play the first download part.

10. The apparatus according to claim 9, wherein the processor is further configured to delete the first download part of the multimedia file from the buffer of the user equipment.

11. A multimedia display device, comprising:
a user interface configured to receive a multimedia type selection command; and
a processor configured to:
search for a service device in a specified range;
determine a service device accessible with an access permission, wherein the service device stores a multimedia file;
search the service device accessible with the access permission for the multimedia file corresponding to the multimedia type selection command;
generate and display a multimedia file list according to the multimedia file corresponding to the multimedia type selection command, wherein the multimedia list comprises name information of the multimedia file corresponding to the multimedia type selection command.

12. The device according to claim 11, wherein the processor is further configured to:
acquire a file directory from the service device accessible with the access permission, wherein the file directory comprises name information of at least one file in the service device;
search for the at least one file according to the name information of the at least one file in the file directory;
acquire file information of the at least one file according to the at least one file, wherein the file information of the at least one file is used to distinguish a type of the at least one file; and
select, from the at least one file according to the file information of the at least one file, the multimedia file corresponding to the multimedia type selection command.

13. The device according to claim 12, wherein the processor is further configured to:
detect whether a folder exists in the file directory, wherein the folder comprises at least one file;
search for the at least one file in the folder when the folder exists in the file directory;
acquire the file information of the at least one file in the folder according to the at least one file in the folder; and
select, from the at least one file in the folder according to the file information of the at least one file in the folder, the multimedia file corresponding to the multimedia type selection command.

14. The device according to claim 11, wherein the user interface is further configured to receive a selection play command, used to select a to-be-played multimedia file from the multimedia list, and wherein the processor is further configured to:
acquire a multimedia file corresponding to the selection play command from the service device according to the selection play command;
download a first download part of the multimedia file into a buffer of the user equipment; and
play the first download part.

15. The device according to claim 14, wherein the processor is further configured to delete the first download part of the multimedia file from the buffer of the user equipment.
